(19) United States
(12) Patent Application Publication
(10) Pub. No.: US 2024/0129595 A1
(43) Pub. Date: Apr. 18, 2024

(54) Video Monitoring Assembly

(71) Applicants: Selina Porter, Louisville, KY (US); Cedric Thompson, Louisville, KY (US)

(72) Inventors: Selina Porter, Louisville, KY (US); Cedric Thompson, Louisville, KY (US)

(21) Appl. No.: 17/964,891

(22) Filed: Oct. 12, 2022

(51) Int. Cl. H04N 21/61; H04N 5/225; H04N 21/2187

(52) U.S. Cl. CPC H04N 21/6125; H04N 5/2252; H04N 5/2254; H04N 21/2187

(57) ABSTRACT

A video monitoring assembly includes an array of personal electronic devices that each stores a video monitoring application. Each of the array of personal electronic devices is in wireless communication with an extrinsic communication network thereby facilitating each of the array of personal electronic devices to be in remote communication with each other. The video monitoring application in each of the personal electronic devices is actuatable to be in remote communication with a selected one of the array of personal electronic devices. An array of video cameras is provided and a respective one of the array of video cameras is in wireless communication with a respective one of the array of personal electronic devices thereby facilitating the respective personal electronic device to receive streaming video from the respective video camera to facilitate a user to view video footage from any location in the world.

### CROSS-REFERENCE TO RELATED APPLICATIONS

Not Applicable

### STATEMENT REGARDING FEDERALLY SPONSORED RESEARCH OR DEVELOPMENT

Not Applicable

### THE NAMES OF THE PARTIES TO A JOINT RESEARCH AGREEMENT

Not Applicable

### INCORPORATION-BY-REFERENCE OF MATERIAL SUBMITTED ON A COMPACT DISC OR AS A TEXT FILE VIA THE OFFICE ELECTRONIC FILING SYSTEM

Not Applicable

### STATEMENT REGARDING PRIOR DISCLOSURES BY THE INVENTOR OR JOINT INVENTOR

Not Applicable

### BACKGROUND OF THE INVENTION

### (1) Field of the Invention

The disclosure relates to video monitoring devices and more particularly pertains to a new video monitoring device for facilitating a user to view streaming video from any location in the world. The device includes a plurality of personal electronic devices and an array of video cameras that are in wireless communication with a respective electronic device. Each of the personal electronic devices stores a video monitoring application that facilitates a user of a respective personal electronic device to view streaming video from any of the array of video cameras. In this way the user of the respective personal electronic device can view real time streaming video from any location in the world.

### (2) Description of Related Art Including Information Disclosed Under 37 CFR 1.97 and 1.98

The prior art relates to video monitoring devices including an interactive map device that includes a map displayed on a personal electronic device and internet hotspots displayed on the map. The prior art discloses an interactive three dimensional tour device that generates three dimensional virtual tour of a location from a two dimensional photograph of the location. The prior art discloses a virtual reality touring device to facilitate a potential resident of a dormitory to virtually tour the dormitory. The prior art discloses a virtual reality tour device that employs a web-based database that facilitates a user to interact with still images or panoramic images which are linked with web-links and hyperlinks. The prior art discloses a location device that facilitates the location of a mobile device to be displayed on a map.

### BRIEF SUMMARY OF THE INVENTION

An embodiment of the disclosure meets the needs presented above by generally comprising an array of personal electronic devices that each stores a video monitoring application. Each of the array of personal electronic devices is in wireless communication with an extrinsic communication network thereby facilitating each of the array of personal electronic devices to be in remote communication with each other. The video monitoring application in each of the personal electronic devices is actuatable to be in remote communication with a selected one of the array of personal electronic devices. An array of video cameras is provided and a respective one of the array of video cameras is in wireless communication with a respective one of the array of personal electronic devices thereby facilitating the respective personal electronic device to receive streaming video from the respective video camera to facilitate a user to view video footage from any location in the world.

There has thus been outlined, rather broadly, the more important features of the disclosure in order that the detailed description thereof that follows may be better understood, and in order that the present contribution to the art may be better appreciated. There are additional features of the disclosure that will be described hereinafter and which will form the subject matter of the claims appended hereto.

The objects of the disclosure, along with the various features of novelty which characterize the disclosure, are pointed out with particularity in the claims annexed to and forming a part of this disclosure.

### BRIEF DESCRIPTION OF SEVERAL VIEWS OF THE DRAWING(S)

The disclosure will be better understood and objects other than those set forth above will become apparent when consideration is given to the following detailed description thereof. Such description makes reference to the annexed drawings wherein:

FIG. 1 is a perspective view of a video monitoring assembly according to an embodiment of the disclosure.

FIG. 2 is a bottom perspective view of a video camera of an embodiment of the disclosure.

FIG. 3 is a front perspective view of a video camera of an embodiment of the disclosure.

FIG. 4 is a back perspective view of a video camera of an embodiment of the disclosure.

FIG. 5 is a perspective view of an embodiment of the disclosure showing a video camera being mounted to an article of headwear.

FIG. 6 is a perspective view of an embodiment of the disclosure showing a video camera being mounted to a pair of eyeglasses.

FIG. 7 is a schematic view of an embodiment of the disclosure.

FIG. 8 is a schematic view of an embodiment of the disclosure showing the relationship between a receiving personal electronic device and a plurality of broadcasting electronic devices.

### DETAILED DESCRIPTION OF THE INVENTION

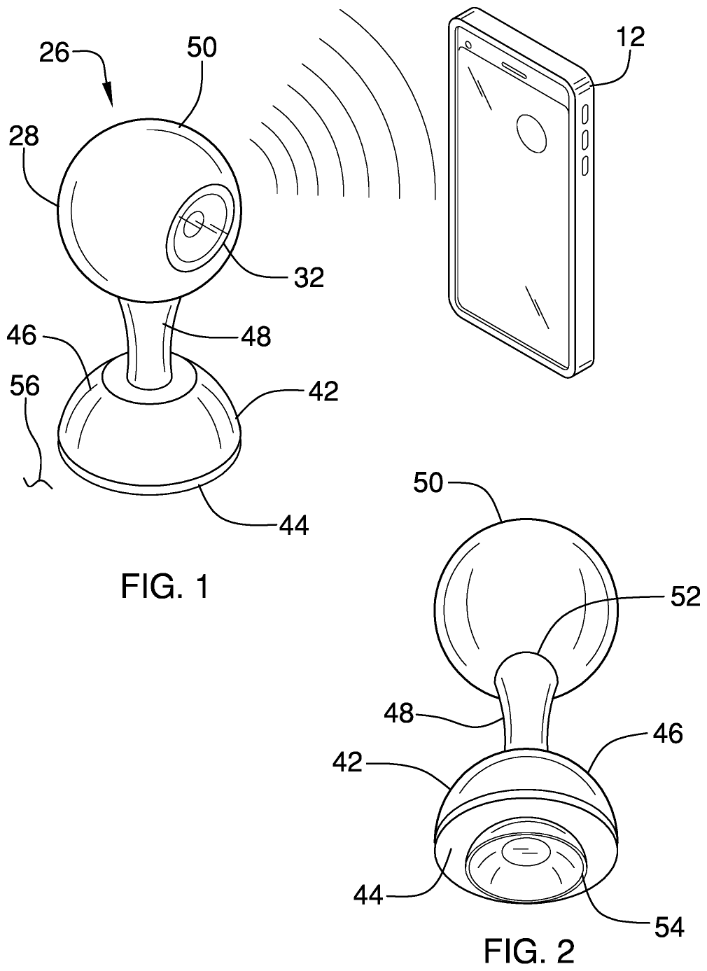

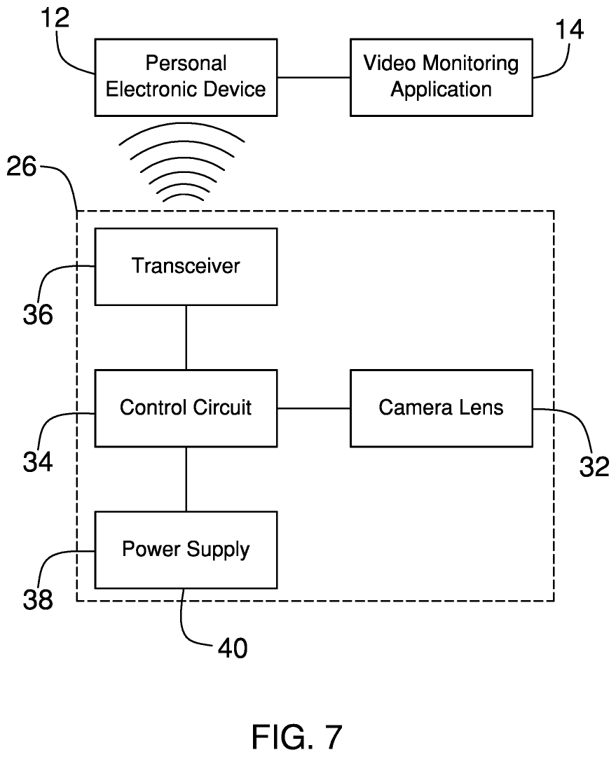

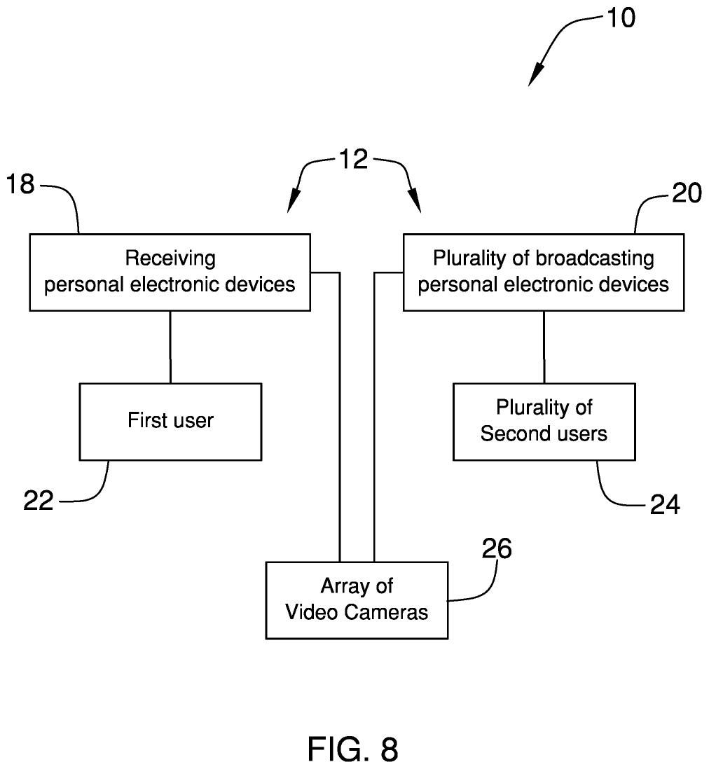

With reference now to the drawings, and in particular to FIGS. 1 through 8 thereof, a new video monitoring device embodying the principles and concepts of an embodiment of the disclosure and generally designated by the reference numeral 10 will be described.

As best illustrated in FIGS. 1 through 8, the video monitoring assembly 10 generally comprises an array of personal electronic devices 12 that each stores a video monitoring application 14. Each of the array of personal electronic devices 12 is in wireless communication with an extrinsic communication network 16 thereby facilitating each of the array of personal electronic devices 12 to be in remote communication with each other. Each of the personal electronic devices 12 may comprise a smart phone or other type of electronic device that has wireless communication capabilities and the video monitoring application 14 may be a smart phone application. The extrinsic communication network 16 may be the internet, a cellular phone network or other type of wireless communication network that facilitates global communication.

The video monitoring application 14 in each of the personal electronic devices 12 is actuatable to be in remote communication with a selected one of the array of personal electronic devices 12 thereby defining a respective one of the array of personal electronic devices 12 as a receiving personal electronic device 18 and defining the remaining array of personal electronic devices 12 as a plurality of broadcasting personal electronic devices 20. Furthermore, the receiving personal electronic device 18 is assigned to a first user 22 and each of the broadcasting personal electronic devices 20 is assigned to a respective one of a plurality of second users 24. The video monitoring application 14 may be named “Lookit” and the video monitoring application 14 may require users to create a unique login to login to the video monitoring application 14.

The video monitoring application 14 in each of the personal electronic devices 12 includes a global positioning feature which includes a plurality of viewing locations. Each of the viewing locations is assigned to a respective one of the broadcasting personal electronic devices 20 which are located around the world. The global positioning feature facilitates the first user 22 to select one of the viewing locations that can be potentially located in any location in the world. The video monitoring application 14 facilitates the receiving personal electronic device 18 to be placed in wireless communication with the broadcasting personal electronic device 20 that is associated with the viewing location which is selected by the first user 22 in the video monitoring application 14.

An array of video cameras 26 is included and a respective one of the array of video cameras 26 is in wireless communication with a respective one of the array of personal electronic devices 12. In this way the respective personal electronic device 12 can receive streaming video from the respective video camera 26. The video monitoring application 14 in each of the personal electronic devices 12 facilitates the receiving personal electronic device 18 to receive the streaming video from a respective one of the broadcasting personal electronic devices 20. The receiving personal electronic device 18 receives streaming video from a chosen one of the broadcasting personal electronic devices 20. In this way the plurality of personal electronic devices 12 and the array of video cameras 26 facilitate the first user 22 to view video footage from any location in the world.

Each of the array of video cameras 26 comprises a housing 28 that has an outer wall 30. The housing 28 has a camera lens 32 that is integrated into the outer wall 30 thereby facilitating the camera lens 32 to capture video footage of the environment surrounding the housing 28. Each of the array of video cameras 26 includes a control circuit 34 that is integrated into the housing 28 and the control circuit 34 is electrically coupled to the camera lens 32. Additionally, the control circuit 34 associated with each of the video cameras 26 is assigned a unique identity with respect to each other.

Each of the array of video cameras 26 includes a transceiver 36 that is integrated into the housing 28. The transceiver 36 is in wireless communication with a respective one of the array of personal electronic devices 12 thereby facilitating the control circuit 34 to be in communication with the video monitoring application 14 in the respective personal electronic device 12. The transceiver 36 may comprise a radio frequency transceiver or the like and the transceiver 36 may employ Bluetooth communication protocols. In this way the transceiver 36 can be synched with the respective personal electronic device 12. Furthermore, the transceiver 36 may employ a WPAN signal thereby facilitating the transceiver 36 to be wirelessly connected to an internet router such that the transceiver 36 broadcasts the video footage directly to the internet. Each of the array of video cameras 26 includes a power supply 38 that is integrated into the housing 28. The power supply 38 is electrically coupled to the control circuit 34 and the power supply 38 comprises at least one battery 40.

As is most clearly shown in FIGS. 1 and 2, the housing 28 comprises a bowl 42 that has a bottom side 44 and a convexly arcuate top side 46, a stem 48 extending upwardly from the convexly arcuate top side 46 and a ball 50 attached to a distal end 52 of the stem 48. A coupler 54 is disposed on the bottom side 44 of the bowl 42 thereby facilitating the coupler 54 to releasably engage a support surface 56 and the camera lens 32 is integrated into the ball 50. The coupler 54 may comprise a suction cup, an adhesive pad, a magnet or other type of multiple use, releasable fastener. In this way the housing 28 can be mounted to a table top, for example, or other stationary object to facilitate the housing 28 be remain motionless. Thus, the housing 28 could be positioned in a restaurant, a night club or other location that might be a popular spot for those with the video monitoring application 14 to view remotely. Furthermore, businesses could potentially advertise their businesses or services to those with the video monitoring application 14.

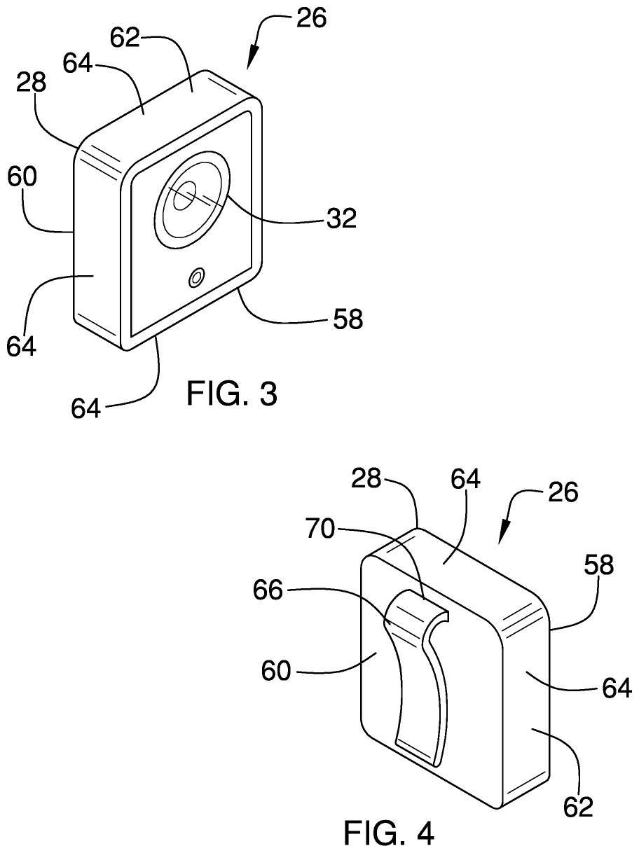

As is most clearly shown in FIG. 3, the housing 28 has a front wall 58, a back wall 60 and a perimeter wall 62 extending between the front wall 58 and the back wall 60 and the perimeter wall 62 has a plurality of intersecting sides 64 such that the housing 28 has a rectangular shape. The camera lens 32 is integrated into the back wall 60 and the housing 28 has a clip 66 that is disposed on the back wall 60. The clip 66 has a first end 70 that is coupled to the back wall 60 and the clip 66 curves downwardly such that the clip 66 rests against the back wall 60 thereby facilitating the clip 66 to engage an article of clothing of a person. In this way the housing 28 can be worn in the convention of a body camera thereby facilitating the camera lens 32 to record the moment to moment activities of the person that is wearing the housing 28. Thus, those with the video monitoring application 14 could view the location of the person and any activities the person might be enjoying.

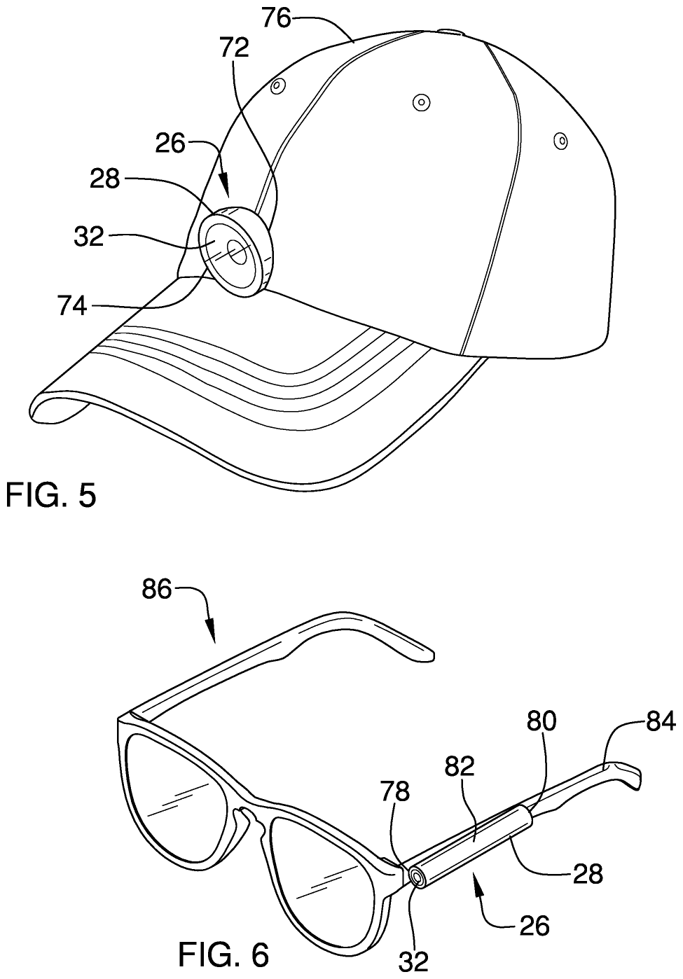

As is most clearly shown in FIG. 5, the housing 28 has a rear wall 72 and a forward wall 74 and the camera lens 32 is integrated into the forward wall 74. Additionally, the rear wall 72 is attached to an article of headwear 76 thereby facilitating the camera lens 32 to be directed forwardly of a person wearing the article of headwear 76. In this way the camera lens 32 can record the moment to moment activities of the person that is wearing the article of headwear 76. Furthermore, those with the video monitoring application 14 could view the location of the person and any activities the person might be enjoying.

As is most clearly shown in FIG. 6, the housing 28 has a first end 78, a second end 80 and an outside wall 82 extending between the first end 78 and the second end 80. The outside wall 82 is continuously arcuate about an axis extending between the first end 78 and the second end 80 such that the housing 28 has a tubular shape. The camera lens 32 is integrated into the first end 78 and the outside wall 82 is attached to an arm 84 of a pair of eyeglasses 86 thereby facilitating the camera lens 32 to be directed forwardly of a person wearing the pair of eyeglasses 86. In this way the camera lens 32 can record the moment to moment activities of the person that is wearing the eyeglasses 86. Additionally, those with the video monitoring application 14 could view the location of the person and any activities the person might be enjoying.

In use, the video monitoring application 14 on the receiving personal electronic device 18 is employed to facilitate the first user 22 to choose which of the viewing locations around the world the first user 22 wishes to view. In this way the streaming video from the various video cameras 26 that are located in the viewing location can be viewed by the first user 22 on their personal electronic device 12. Thus, the first user 22 can experience the sights and sounds of almost any location in the world without being required to travel. Furthermore, businesses could employ the video monitoring application 14 to advertise their businesses to those with the video monitoring application 14 when those with the video monitoring application 14 chose to view video footage from the location in which the business is located.

With respect to the above description then, it is to be realized that the optimum dimensional relationships for the parts of an embodiment enabled by the disclosure, to include variations in size, materials, shape, form, function and manner of operation, assembly and use, are deemed readily apparent and obvious to one skilled in the art, and all equivalent relationships to those illustrated in the drawings and described in the specification are intended to be encompassed by an embodiment of the disclosure.

Therefore, the foregoing is considered as illustrative only of the principles of the disclosure. Further, since numerous modifications and changes will readily occur to those skilled in the art, it is not desired to limit the disclosure to the exact construction and operation shown and described, and accordingly, all suitable modifications and equivalents may be resorted to, falling within the scope of the disclosure. In this patent document, the word “comprising” is used in its non-limiting sense to mean that items following the word are included, but items not specifically mentioned are not excluded. A reference to an element by the indefinite article “a” does not exclude the possibility that more than one of the element is present, unless the context clearly requires that there be only one of the elements.

I claim:

1. A video monitoring assembly for facilitating a user of a personal electronic device to view video footage captured by subscribers located around the world, said assembly comprising:
an array of personal electronic devices, each of said personal electronic devices storing a video monitoring application, each of array of personal electronic devices being in wireless communication with an extrinsic communication network thereby facilitating each of said array of personal electronic devices to be in remote communication with each other, said video monitoring application in each of said personal electronic devices being actuatable to be in remote communication with a selected one of said array of personal electronic devices thereby defining a respective one of said array of personal electronic devices as a receiving personal electronic device and defining the remaining array of personal electronic devices as a plurality of broadcasting personal electronic devices; and
an array of video cameras, a respective one of said array of video cameras being in wireless communication with a respective one of said array of personal electronic devices thereby facilitating said respective personal electronic device to receive streaming video from said respective video camera, said video monitoring application in each of said personal electronic devices facilitating said receiving personal electronic device to receive the streaming video from a respective one of said broadcasting personal electronic devices wherein said plurality of personal electronic devices and said array of video cameras is configured to facilitate a user to view video footage from any location in the world.

2. The assembly according to claim 1, wherein:
said receiving personal electronic device is assigned to a first user;
each of said broadcasting personal electronic devices is assigned to a respective one of a plurality of second users;
said video monitoring application in each of said personal electronic devices includes a global positioning feature which includes a plurality of viewing locations, each of said viewing locations being assigned to a respective one of said broadcasting personal electronic devices which are located around the world;
said global positioning feature facilitating the first user to select one of said viewing locations; and
said video monitoring application facilitates said receiving personal electronic device to be placed in wireless communication with said broadcasting personal electronic device being associated with said viewing location that is selected by the first user in said video monitoring application.

3. The assembly according to claim 1, wherein each of said array of video cameras comprises:
a housing having an outer wall, said housing having a camera lens being integrated into said outer wall thereby facilitating said camera lens to capture video footage of the environment surrounding said housing;
a control circuit being integrated into said housing, said control circuit being electrically coupled to said camera lens, said control circuit associated with each of said video cameras being assigned a unique identity with respect to each other;
a transceiver being integrated into said housing, said transceiver being in wireless communication with a respective one of said array of personal electronic devices thereby facilitating said control circuit to be in communication with said video monitoring application in said respective personal electronic device; and
a power supply being integrated into said housing, said power supply being electrically coupled to said control circuit, said power supply comprising at least one battery.

4. The assembly according to claim 3, wherein said housing comprises a bowl having a bottom side and a convexly arcuate top side, a stem extending upwardly from said convexly arcuate top side and a ball attached to a distal end of said stem, said housing having a coupler being disposed on said bottom side of said bowl thereby facilitating said coupler to releasably engage a support surface, said camera lens being integrated into said ball.

5. The assembly according to claim 3, wherein said housing has a front wall, a back wall and a perimeter wall extending between said front wall and said back wall, said perimeter wall having a plurality of intersecting sides such that said housing has a rectangular shape, said camera lens being integrated into said back wall, said housing having a clip being disposed on said back wall, said clip having a first end being coupled to said back wall, said clip curving downwardly such that said clip rests against said back wall thereby facilitating said clip to engage an article of clothing of a user.

6. The assembly according to claim 3, wherein said housing has a rear wall and a forward wall, said camera lens being integrated into said forward wall, said rear wall being attached to an article of headwear thereby facilitating said camera lens to be directed forwardly of a user wearing said article of headwear.

7. The assembly according to claim x, wherein said housing has a first end, a second end and an outside wall extending between said first end and said second end, said outside wall being continuously arcuate about an axis extending between said first end and said second end such that said housing has a tubular shape, said camera lens being integrated into said first end, said outside wall being attached to an arm of a pair of eyeglasses thereby facilitating said camera lens to be directed forwardly of a user wearing said pair of eyeglasses.

8. A video monitoring assembly for facilitating a user of a personal electronic device to view video footage captured by subscribers located around the world, said assembly comprising:
an array of personal electronic devices, each of said personal electronic devices storing a video monitoring application, each of array of personal electronic devices being in wireless communication with an extrinsic communication network thereby facilitating each of said array of personal electronic devices to be in remote communication with each other, said video monitoring application in each of said personal electronic devices being actuatable to be in remote communication with a selected one of said array of personal electronic devices thereby defining a respective one of said array of personal electronic devices as a receiving personal electronic device and defining the remaining array of personal electronic devices as a plurality of broadcasting personal electronic devices, said receiving personal electronic device being assigned to a first user, each of said broadcasting personal electronic devices being assigned to a respective one of a plurality of second users, said video monitoring application in each of said personal electronic devices including a global positioning feature which includes a plurality of viewing locations, each of said viewing locations being assigned to a respective one of said broadcasting personal electronic devices which are located around the world, said global positioning feature facilitating the first user to select one of said viewing locations, said video monitoring application facilitating said receiving personal electronic device to be placed in wireless communication with said broadcasting personal electronic device being associated with said viewing location that is selected by the first user in said video monitoring application; and
an array of video cameras, a respective one of said array of video cameras being in wireless communication with a respective one of said array of personal electronic devices thereby facilitating said respective personal electronic device to receive streaming video from said respective video camera, said video monitoring application in each of said personal electronic devices facilitating said receiving personal electronic device to receive the streaming video from a respective one of said broadcasting personal electronic devices, said receiving personal electronic device receiving streaming video from a chosen one of said broadcasting personal electronic devices wherein said plurality of personal electronic devices and said array of video cameras is configured to facilitate the first user to view video footage from any location in the world, each of said array of video cameras comprising:
a housing having an outer wall, said housing having a camera lens being integrated into said outer wall thereby facilitating said camera lens to capture video footage of the environment surrounding said housing;
a control circuit being integrated into said housing, said control circuit being electrically coupled to said camera lens, said control circuit associated with each of said video cameras being assigned a unique identity with respect to each other;
a transceiver being integrated into said housing, said transceiver being in wireless communication with a respective one of said array of personal electronic devices thereby facilitating said control circuit to be in communication with said video monitoring application in said respective personal electronic device; and
a power supply being integrated into said housing, said power supply being electrically coupled to said control circuit, said power supply comprising at least one battery;
wherein said housing comprises a bowl having a bottom side and a convexly arcuate top side, a stem extending upwardly from said convexly arcuate top side and a ball attached to a distal end of said stem, said housing having a coupler being disposed on said bottom side of said bowl thereby facilitating said coupler to releasably engage a support surface, said camera lens being integrated into said ball;
wherein said housing has a front wall, a back wall and a perimeter wall extending between said front wall and said back wall, said perimeter wall having a plurality of intersecting sides such that said housing has a rectangular shape, said camera lens being integrated into said back wall, said housing having a clip being disposed on said back wall, said clip having a first end being coupled to said back wall, said clip curving downwardly such that said clip rests against said back wall thereby facilitating said clip to engage an article of clothing of a user;
wherein said housing has a rear wall and a forward wall, said camera lens being integrated into said forward wall, said rear wall being attached to an article of headwear thereby facilitating said camera lens to be directed forwardly of a user wearing said article of headwear; and
wherein said housing has a first end, a second end and an outside wall extending between said first end and said second end, said outside wall being continuously arcuate about an axis extending between said first end and said second end such that said housing has a tubular shape, said camera lens being integrated into said first end, said outside wall being attached to an arm of a pair of eyeglasses thereby facilitating said camera lens to be directed forwardly of a user wearing said pair of eyeglasses.
